(19) United States
(12) Patent Application Publication
(10) Pub. No.: US 2020/0065692 A1
(43) Pub. Date: Feb. 27, 2020

(54) DEFUZZIFICATION APPARATUS AND METHOD

(71) Applicant: British Telecommunications Public Limited Company, London (GB)

(72) Inventors: Benham Azvine, London (GB); Martin Trevor, London (GB)

(73) Assignee: British Telecommunications Public Limited Company, London (GB)

(21) Appl. No.: 16/466,828

(22) PCT Filed: Dec. 5, 2017
(86) PCT No.: PCT/EP2017/081557

§ 371 Date: Jun. 5, 2019

(30) Foreign Application Priority Data
Dec. 5, 2016 (EP) 16202216.4
Dec. 5, 2016 (GB) 1620630.2

(51) Int. Cl. G06N 5/04

(52) U.S. Cl. CPC G06N 5/048

(57) ABSTRACT

A defuzzification apparatus for defuzzification of fuzzy data representative of one or more entities or events, the fuzzy data specifying for each of the one or more entities or events, a membership level, the defuzzification apparatus including one or more processors configured to generate, using the fuzzy data, a set of computer executable instructions representative of a function of the fuzzy data, and execute, using a predetermined fuzzy membership value, the set of computer executable instructions to determine crisp data. The defuzzification apparatus may be coupled to crisp data processors configured to receive the crisp data and perform crisp data processing on the received crisp data so as to generate further crisp data. The crisp data processor may be coupled to a fuzzification apparatus including one or more processors configured to process the received further crisp data to generate therefrom further fuzzy data.

### CROSS-REFERENCE TO RELATED APPLICATION

The present application is a National Phase entry of PCT Application No. PCT/EP2017/081557, filed Dec. 5, 2017, which claims priority from Great Britain Patent Application No. 1620630.2 filed Dec. 5, 2016 and European Patent Application No. 16202216.4 filed Dec. 5, 2016 each of which are hereby fully incorporated herein by reference.

### TECHNICAL FIELD

The present disclosure relates to the defuzzification of fuzzy data representative entities or events.

### BACKGROUND

There are numerous data processing systems for processing distinct or precise data, herein referred to as crisp data. The applicability of such data processing systems tends to be limited to the processing of crisp data, and data processing systems generally require crisp data as an input.

Fuzzy set theory relating to sets of indistinct data is a well-established approach to modeling uncertainty. Fuzzy set theory has numerous useful applications in areas including but not limited to control in industrial and consumer devices through to document search and analysis.

Modification of data processing systems for processing crisp data to support fuzzy data can be very complex and error prone.

### SUMMARY

The present inventor has realized that it would be beneficial to have a system that permits the evaluation of functions intended for distinct data for data input that is indistinct.

In a first aspect, the present disclosure provides a defuzzification apparatus for the defuzzification of fuzzy data representative of one or more entities or events, and specifying, for each of the entities or events, a membership level or grade of membership. Entities may be physical entities, objects or items, such as devices, people, or buildings. Events may be behaviors, actions, changes, or other occurrences relating to one or more physical entities. The defuzzification apparatus comprises one or more processors configured to: generate, based on the fuzzy data, a set of computer executable instructions representative of some function of the fuzzy data, and execute, using a predefined fuzzy membership value, the set of computer executable instructions to determine crisp data.

An event may be a physical or network security event, i.e. an event that relates to physical or network security. For example, an event may be a time-stamped event relating to people accessing resources using a security facility, such as access to a secure building via a badge-locked door, or access to a secure network via an authentication system.

An entity may be a physical entity, object, or item such as a device, building, or person. An entity may have attributes that may be physical or network security attributes, i.e. attributes that relate to physical or network security. For example, the attributes or an entity may include a building access control parameter, and/or a parameter relating to access to a secure network via an authentication system.

The one or more processors may be further configured to generate, based on the fuzzy data, an initial set of computer executable instructions representative of the fuzzy data, and determine the function of the fuzzy data by executing the initial set of computer executable instructions, thereby determining the set of computer executable instructions representative of the function of the fuzzy data. The one or more processors may be configured to implement multithread execution.

The function of the fuzzy data may be equal to one or more a fuzzy set operators applied to some or all of the fuzzy data.

The computer executable instructions in the set of computer implementable instructions may be ordered by membership level. The one or more processors may be configured to execute the set of computer implementable instructions in membership level order. The set of computer implementable instructions may specify a lexicographical ordering for the fuzzy input.

In a further aspect, the present disclosure provides a system comprising: the defuzzification apparatus according to any preceding aspect, wherein the defuzzification apparatus is configured to output the crisp data for use by one or more crisp data processors; and a fuzzification apparatus comprising one or more processors configured to receive, responsive to the defuzzification apparatus outputting the crisp data, further crisp data from the one or more crisp data processors, and to process the received further crisp data to generate therefrom further fuzzy data.

The fuzzification apparatus may be configured to process the received further crisp data using one or more parameter values used by the defuzzification apparatus in the determination of the crisp data. The fuzzification apparatus may be configured to process the received further crisp data using the predefined fuzzy membership value.

The system may further comprise the one or more crisp data processors. The one or more crisp data processors may be configured to: receive the crisp data from the defuzzification apparatus; perform crisp data processing on the received crisp data so as to generate the further crisp data; and output the further crisp data for use by the fuzzification apparatus.

In a further aspect, the present disclosure provides a defuzzification method for generating crisp data from fuzzy data. The method comprises generating based on the fuzzy data, a set of computer executable instructions representative of a function of the fuzzy data, and executing, using a predefined fuzzy membership value, the set of one or more computer executable instructions to determine crisp data.

The method may further comprise: outputting the crisp data for use by one or more crisp data processors; responsive to outputting the crisp data for use by one or more crisp data processors, receiving, from the one or more crisp data processors, further crisp data; and processing the received further crisp data to generate therefrom further fuzzy data.

In a further aspect, the present disclosure provides a program or plurality of programs arranged such that when executed by a computer system or one or more processors it/they cause the computer system or the one or more processors to operate in accordance with the method of the preceding aspect.

In a further aspect, the present disclosure provides a machine readable storage medium storing a program or at least one of the plurality of programs according to the preceding aspect.

### BRIEF DESCRIPTION OF THE DRAWINGS

Embodiments of the present disclosure will now be described, by way of example only, with reference to the accompanying drawings, in which:

FIG. 1 is a schematic illustration (not to scale) of a computer system.

FIG. 2 is a schematic illustration (not to scale) of a fuzzy calculation apparatus for evaluating functions of fuzzy data.

FIG. 3 is a schematic illustration (not to scale) of a defuzzification module of the fuzzy calculation apparatus.

FIG. 4 is a process flow chart showing a fuzzy calculation process performable by the fuzzy calculation apparatus.

FIG. 5 is a process flow chart showing a further fuzzy calculation process performable by the fuzzy calculation apparatus;

FIG. 6 is a schematic illustration (not to scale) of a graph representation of continuous interval values fuzzy sets.

FIG. 7 is a process flow chart showing a further fuzzy calculation process performable by the fuzzy calculation apparatus.

### DETAILED DESCRIPTION

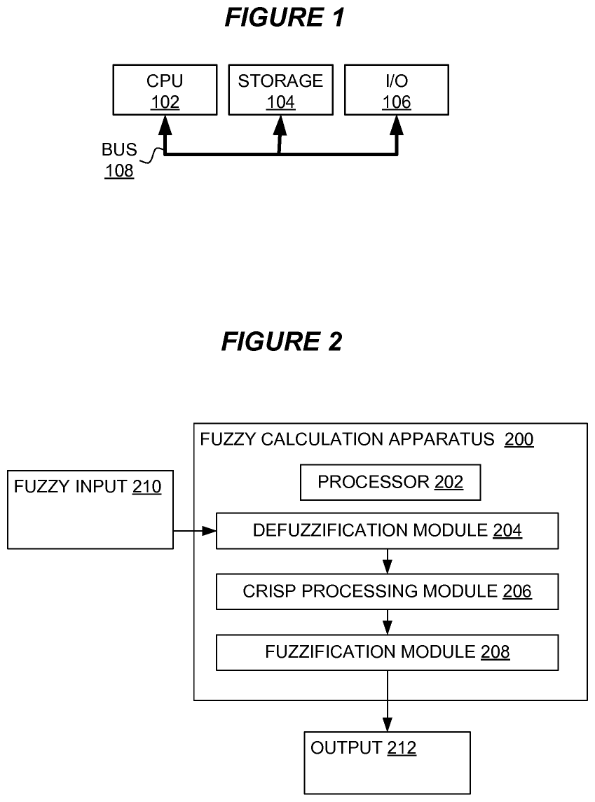

FIG. 1 is a schematic illustration (not to scale) of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of a fuzzy calculation apparatus 200 for evaluating functions of indistinct, or fuzzy, data in accordance with one embodiment of the present disclosure.

The fuzzy calculation apparatus 200 comprises a processor 202, a defuzzification module 204, a crisp processing module 206, and a fuzzification module 208.

In this embodiment, the modules 204-208 (i.e. the defuzzification module 204, the crisp processing module 206, and the fuzzification module 208) correspond to functions and algorithms which are implemented in software. The software may consist of computer executable instructions stored on a computer readable media such as a memory or other type of storage device which may include one or more storages such as storage 104 of a generalized computing device such as that depicted in FIG. 1. The term “computer readable media” is also used to represent any means by which the computer readable instructions may be received by a computer.

In some embodiments, the modules 204-208 may be software, hardware, firmware, or any combination thereof. Multiple functions may be performed in one or more modules as desired, and the embodiments described herein are merely examples.

In this embodiment, the software corresponding to the modules 204-208 is executed on the processor 202. The processor 202 is configured to undertake all or part of the function of the fuzzy calculation apparatus 200. Apparatus, including the processor 202, for implementing the fuzzy calculation apparatus 200, and performing the method to be described later below, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM, etc., or any combination of these or other storage media. For example, the processor 202 can be one or more CPUs such as CPU 102 of a generalized computing device such as that depicted in FIG. 1. Accordingly the particular embodiments depicted herein are purely exemplary and any suitable configuration of components could alternatively be employed.

In this embodiment, the defuzzification module 204 is adapted to receive a fuzzy input 210. Illustrative examples of the fuzzy input 210 are provided later below. The fuzzy input 210 can be in the form of, for example, a data structure, table, database, or similar. The fuzzy input 204 can be specified by a component or entity external to the fuzzy calculation apparatus 200, for example, the fuzzy input 210 may be specified by a user of the fuzzy calculation apparatus 200 using an appropriate user interface of the fuzzy calculation apparatus 200 which may include one or more I/O interfaces such as I/O interface 106 of a generalized computing device such as that depicted in FIG. 1.

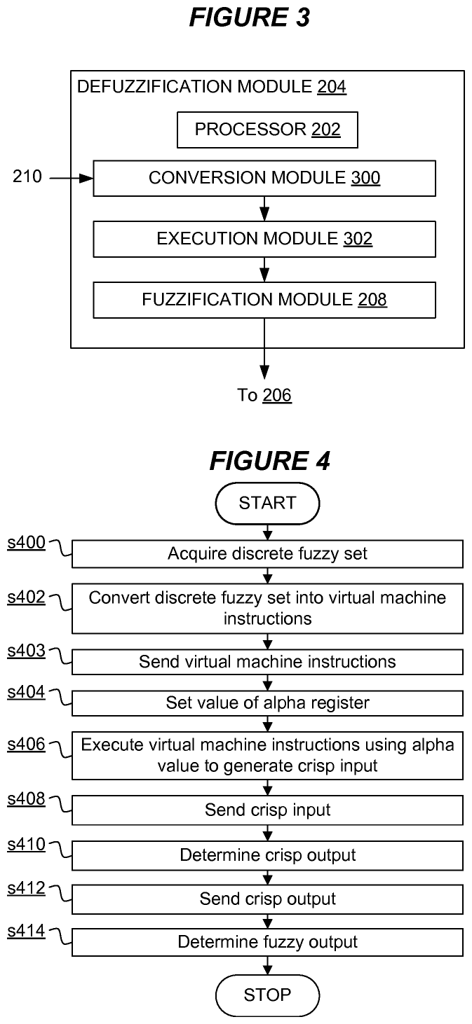

The defuzzification module 204 is described in more detail later below with reference to FIG. 3. In this embodiment, the defuzzification module 204 is configured to convert the fuzzy input 210 to crisp (i.e. non-fuzzy) data, which is hereinafter referred to as the “crisp input”. In other words, the defuzzification module 204 is configured to defuzzify fuzzy or indistinct data to produce crisp or distinct data. The defuzzification module 204 is operatively connected to the crisp processing module 206 such that the output of the defuzzification module 204, i.e. the crisp input, is received at an input of the crisp processing module 206.

In this embodiment, the crisp processing module 206 is configured to process the received crisp input, and to evaluate one or more functions based on the received crisp input. The one or more functions evaluated by the crisp processing module 206 may be any appropriate crisp functions, illustrative examples of which are provided later below. The crisp processing module 206 may be a crisp processing engine (e.g. a crisp rule engine) which is a computer program that is used to provide information given a crisp input. An output of the crisp processing module 206 is the evaluated one or more functions. The output of the crisp processing module 206 is crisp data and is hereinafter referred to as the “crisp output”. The crisp processing module 206 is operatively connected to the fuzzification module 208 such that the output of the crisp processing module 206, i.e. the crisp output, is received at an input of the fuzzification module 208.

In this embodiment, the fuzzification module 208 is configured to process the received crisp output, and to convert the crisp output into fuzzy data. This fuzzy data is output from the fuzzification module 208 as a fuzzy output 212. In other words, the fuzzification module 208 is configured to fuzzify crisp or distinct data to produce fuzzy or indistinct data.

Illustrative examples of the fuzzy output 212 are provided later below. The fuzzy output 212 can be in the form of, for example, a data structure, table, database, or similar. The fuzzy calculation apparatus 200 can provide the fuzzy output 210 for use by a component or entity external to the fuzzy calculation apparatus 200, for example, the fuzzy output 212 may be displayed to a user of the fuzzy calculation apparatus 200 using an appropriate user interface of the fuzzy calculation apparatus 200 and/or the fuzzy output 212 may be stored in a storage 104 of a computer system, such as a storage associated with or comprised in the fuzzy calculation apparatus 200.

In some embodiments, the fuzzification of the crisp output by the fuzzification module 208 includes using at least some information used by the defuzzification module 204 when defuzzifying the fuzzy input 210. Thus, the defuzzification module 204 and the fuzzification module 208, in effect, form a wrapper for the crisp processing module 206.

FIG. 3 is a schematic illustration (not to scale) showing further details of the defuzzification module 204. In this embodiment, the defuzzification module 204 comprises a conversion module 300 and an execution module 302.

The conversion module 300 is configured to receive the fuzzy input 210.

In this embodiment, some or all of the functions and algorithms of the modules 204-208 are implemented as a virtual machine which is run by the processor 200. The conversion module 300 is configured to convert the received fuzzy input 210 into a set of instructions that are performable by the virtual machine run by the processor 200.

The conversion module 300 is operatively coupled to the execution module 302 such that an output of the conversion module 300, i.e. the set of virtual machine instructions representative of the fuzzy input 210, may be sent from the conversion module 300 to the execution module 302.

The execution module 302 is configured to execute the virtual machine instructions received from the conversion module so as to generate the crisp input. Operation of the execution module 302 is described in more detail later below with reference to FIGS. 3 to 7.

In this embodiment, the execution module 302 is configured to operate in two different modes. In other words, the virtual machine instructions can be executed in two different modes. In particular, the execution module 302 is configured to operate in either “explicit mode” or “implicit mode”, which will be described in more detail later below. In some embodiments, two different execution modules may be implemented; one execution module configured to operate in explicit mode, and the other execution module configured to operate in implicit mode. In some embodiments, multiple different virtual machines may be run on the processor 200, with one version of the virtual machine arranged to operate in explicit mode, and a different version of the virtual machine configured to operate in implicit mode. It some situations, it tends to be more efficient to implement two different execution modules or two different virtual machines as opposed to implementing a single execution module in a single virtual machine that tests which mode (explicit or implicit) to operate in and execute instructions accordingly.

The execution module 302 is operatively coupled to the crisp processing module 206 such that an output of the execution module 302, i.e. the crisp input, may be sent from the execution module 302 to the crisp processing module 206.

In this embodiment, some or all of the functions and algorithms of the modules 204-208 are implemented as a virtual machine which is run by the processor 200. The implementation of the virtual machine may involve specialized hardware, software, or a combination thereof. Information pertaining to registers, objects and instructions comprised within the virtual machine will now be provided. This information is useful in understanding the operation of the virtual machine and its use in performing a fuzzy calculation process. Different examples of fuzzy calculations which may be performed using the virtual machine are described in more detail later below with reference to FIGS. 4 to 7.

In this embodiment, the virtual machine comprises, for each of one or more threads, a respective copy of the following registers, objects and instructions:
alpha. This is a register containing a value of a membership function within the range 0 to 1. The value in alpha may be set by a user of the fuzzy calculation apparatus 200. In some situations, the value in alpha is not set, depending on a value of the flag alphaIsSet.
alphaIsSet. This is a status flag indicating whether the alpha register is set. For example, alphaIsSet=T may indicate that alpha is set, whereas alphaIsSet=F may indicate that alpha is not set.
container. This is an object, for example a user-supplied object, in which data is stored. The container may be configured to store of one or more membership values and one or more commands and arguments.
continuationPointer. This is a pointer to the next instruction to be executed during a calculation process.
execMode. This is a register containing an indication of an execution mode of the virtual machine execution mode. For example, the execMode may indicate operation in implicit or explicit modes, which will be described in more detail later below.
execStatus. This is a register containing an indication of the execution status of a thread being processed by the virtual machine. The execStatus register may, for example, indicate that a thread is being executed, is ready to be executed, that execution is suspended, or that execution of a thread has terminated.
execPtr. This is a register containing a current execution address.

In this embodiment, the status register execStatus of each thread is visible to the container. Also, each container is configured to provide the following virtual machine registers (per thread, in the case of multi-thread operations):
containerMethod. This indicates a method to be executed by the container.
containerArgs. This register includes zero or more argument registers to be used by the container in operation. The argument registers may be numbered, e.g., 1 to N.
containerVM. This register provides a link to an associated virtual machine thread. This may be used to restart suspended virtual machine operation in certain modes of operation, as described in more detail later below.

Further, each container comprises at least one stack configured to perform the following objects and operations:
container.pushCommand. This object stores containerMethod and containerArgs on a container stack.
container.execCommand. This operation executes containerMethod on containerArgs. Following execution of containerMethod, control is returned to the calling virtual machine.
container.pushAlpha. This object stores the current value of alpha on top of a container stack.

In this embodiment, the virtual machine is configured to perform the following instructions. In this embodiment, the instructions cause the container to execute the container stack (this is referred to herein as “explicit mode”). However, in some embodiments, one or more of the instructions are instead stored in the container for later processing (this is referred to herein as “implicit mode”).
“Initialize” (INIT). This instruction initializes the virtual machine and causes the virtual machine to allocate registers for the arguments, containerArgs. The arguments of this instruction may include an address for the virtual machine to jump to after register allocation.
“Evaluate and Terminate” (ETRM). An argument for this instruction is a threshold for alpha, i.e. alphaThreshold. This instruction may cause the virtual machine to execute commands on the container command stack, and return the calculated value(s). Also, execMode may be set to “Terminated”.
“Terminate” (TRM). An argument for this instruction is a threshold for alpha, i.e. alphaThreshold. This instruction may cause the virtual machine to set execMode to “Terminated”.
“Switch” (SWT). Arguments for this instruction may include: N (specifying a number of addresses); a method to evaluate (which may be specified by the parameter alphaReg); and N+2 addresses (which may be indexed 0 to N+1). This instruction may cause the virtual machine to evaluate the method specified by alphaReg. If the calculated result is within the range 0 to N−1, the virtual machine may jump to that address in the container command stack. If the calculated result is greater than or equal to N, the virtual machine may jump to address N in the container command stack. If the calculated result is less than 0, the virtual machine may jump to address N+1 in the container command stack. Advantageously, the Switch operation, SWT, may be used to optimize explicit mode execution of larger sets, for example by allowing execution to jump to a membership level without making incremental changes. This tends to be particularly useful for continuous interval-valued sets.
“Jump” (IMP). An argument for this instruction may be an address of the container stack. This instruction may cause the virtual machine to set execPtr to the address specified in the argument and continue execution.
“Set Container Call” (SCC). Arguments for this instruction may include: N (specifying a number of arguments); a parameter containerCommand (specifying the action to be taken by the container); and N arguments (in particular, <argument₁>, . . . , <argument_{N}>). This instruction may cause the virtual machine to set containerMethod to the command <containerCommand>, and to set argument registers 1-N as the arguments <argument₁>, . . . , <argument_{N}> respectively. In some embodiments, the current value of the alpha register, containerMethod, and the arguments 1-N are pushed onto the container command stack.
“Replace Container Arguments” (RCA). Arguments for this instruction may include: N (specifying a number of arguments); and, for each of the N specified arguments a pair of parameters argumentNumber and argumentValue. This instruction may cause the virtual machine to overwrite each argumentNumber with the associated argumentValue. In some embodiments, the container call is pushed to execute the command <containerCommand> with arguments 1-N onto the container command stack. Also in some embodiments, the current value of the alpha register is pushed onto the container command stack.
“Incremental Add to Container” (IAC). Arguments for this instruction may include a parameter <object> specifying an object to be added to the container command stack, and a parameter <alphaRef> which specifies a membership value for that <object>. As described in more detail later below, the virtual machine instructions are ordered by membership level, and thus alphaRef corresponds to a virtual machine address for that object. This instruction may cause the virtual machine to add the <object> to the container command stack.
“Incremental Remove from Container” (IRC). Arguments for this instruction may include a parameter <object> specifying an object to be remove from the container command stack, and a parameter <alphaRef> which specifies a membership value for that <object> (which, since the virtual machine instructions are ordered by membership level, corresponds to a virtual machine address for that object). This instruction may cause the virtual machine to remove the <object> from the container command stack.
“Compare If Greater Evaluate and Return” (CGER). Arguments for this instruction may include a parameter <alphaThreshold> specifying a threshold for the alpha register. This instruction may cause the virtual machine to determine if the value stored in the alpha register is greater than alphaThreshold. Also, this instruction may cause the virtual machine to, if it is determined that the value stored in alpha is greater than alphaThreshold, cause the container to execute commands on the container command stack and return the calculated result.
“Compare If Greater Return” (CGR). Arguments for this instruction may include a parameter <alphaThreshold> specifying a threshold for the alpha register. This instruction may cause the virtual machine to, if the alpha register is unset, load alphaThreshold into the alpha register, execute the container, and subsequently unset the alpha register. This instruction may cause the virtual machine to, if the value stored in the alpha register is greater than alpha Threshold, return control to the caller.

FIG. 4 is a process flow chart showing certain steps of an example fuzzy calculation process performed by the fuzzy calculation apparatus 200.

In this embodiment, the fuzzy calculation apparatus 200 is configured to determine the number elements of the fuzzy input 210 that have a membership value greater than or equal to a user specified value. However, in other embodiments, fuzzy calculation apparatus 200 is configured to perform some other operation.

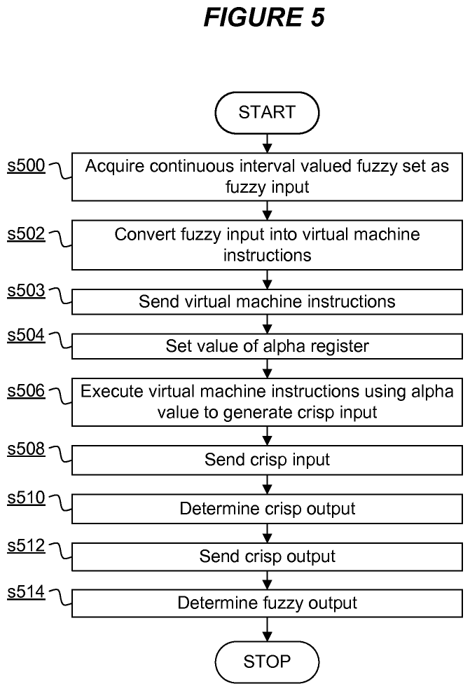

The example fuzzy calculation process described below with reference to FIG. 4 is a process performed on a discrete fuzzy input 210. A further example fuzzy calculation process performed on a continuous fuzzy input 210 is described in more detail later below with reference to FIG. 5, after a description of the process of FIG. 4.

Initially, at s400 the conversion module 300 of the defuzzification module 204 acquires the discrete fuzzy input 210.

For illustration purposes only, in this embodiment the discrete fuzzy input 210 is a discrete fuzzy set comprising a pair (A, m_{A}) where A is a discrete set and m_{A}:A→[0,1] is a membership function. For each discrete element x ∈A, the value m_{A}(x) is called the grade of membership of x in (A, m_{A}). For a finite set A={x₁, . . . ,x,}, the fuzzy set (A, m_{A}) is denoted by {x₁/m_{A}(x₁), . . . , xₙ/m_{A}(xₙ)}.

In this embodiment, the elements x of the discrete set A are representative of physical entities or objects, such as devices, people, or buildings. The entities may have one or more attributes that are physical or network security attributes, i.e. attributes that relate to physical or network security. Examples of physical or network security attributes include but are not limited to building access control, access to a secure network via an authentication system, etc.

In some embodiments, one or more of the elements x of the discrete set A are representative of events. An event may indicate a behavior, action, change, measurement of, or other occurrence relating to one or more physical entities. In some embodiments, the events are physical or network security events, i.e. events that relate to physical or network security. An event may have an attribute that relates to physical or network security. For example, an event may be a time-stamped event relating to people accessing resources using a security facility, such as access to a secure building via a badge-locked door, or access to a secure network via an authentication system. Such events can include an indication of a type of occurrence, such as an “entry occurrence” and an “exit occurrence” indicating commencement and cessation of access to the resource. Further, events can include an identification of a resource being accessed, such as a building or network identifier. Sequences of such events can be identified using sequence extending relations between events such as identity of employee identifier and a temporal limitation. Examples of data sets of events include, inter alia: network access logs; software monitoring logs; processing unit status information events; physical security information such as building access events; data transmission records; access control records for secured resources; indicators of activity of a hardware or software component, a resource or an individual; and profile information for profiling a hardware or software component, a resource or an individual.

An ability to process fuzzy sets representative of entities or events using functions intended for distinct data tends to valuable in security applications, for example, for the evaluation of security rules and the like for attack detection, or to determine an insecure state of system operation.

In this embodiment, for illustrative purposes only, A is a finite set containing employees that have managerial responsibility for a large number of junior employees. The set A comprises four entities (i.e. employees), namely a, b, c, d. In this embodiment, the set (A, m_{A}) is {a/1, b/0.4, c/0.9, d/0.5}.

At s402, the conversion module 300 converts the fuzzy input 210, i.e. the x-mu fuzzy set (A, m_{A}), into a set of virtual machine instructions. Any appropriate algorithm may be used by the conversion module 300 to generate the set of virtual machine instructions. The virtual machine instructions may comprise a data structure or code used internally by the virtual machine. In some embodiments, the virtual machine instructions are in the form of an intermediate representation of the fuzzy input 210.

In this embodiment, virtual machine instructions corresponding to the fuzzy input 210 comprise a sequence of operations representing the fuzzy input 210. These instructions are ordered by membership level m_{A}(x). Optionally, these instructions can also be linked by an order defined on the elements x ∈A. For example, discrete sets could use a lexicographic ordering on elements. The conversion (or compilation) of a discrete fuzzy set into virtual machine instructions can be accomplished by process of sorting the elements by membership and, optionally, by lexicographic order. Each membership level generates a CGR command, and elements at each membership level generate IAC commands, with initialization and termination commands added before and after the main body of instructions.

Virtual machine instructions corresponding to the fuzzy input (A, m_{A})={a/1, b/0.4, c/0.9, d/0.5} are given by the following data structure:

Data Structure 1.

| instruction | op1 | op2 | op3 |
|---|---|---|---|
| INIT | 1 | A5 | A7 |
| CGR | 1.0 | | |
| IAC | a | A6 | A25 |
| CGR | 0.9 | | |
| IAC | c | A12 | A19 |
| CGR | 0.5 | | |
| IAC | d | A18 | A29 |
| CGR | 0.4 | | |
| IAC | b | A24 | A13 |
| TRM | | | |

In this embodiment, address locations of the elements of above Data Structure 1 are A1, A2, A3, . . . , and so on. Address locations are assigned in text reading order, i.e. such that the instruction “INIT” is at location A1, the value “1” is at location A2, the value “A5” is at location A3, the value “A7” is at location A4, the instruction “CGR” is at location A5, and so on. Empty boxes of the above data structure are not assigned an address.

The first column of the data structure (i.e. the “instruction” column) contains virtual machine instructions explained in more detail earlier above.

The remaining columns store arguments (operands) used by each instruction. The number of arguments for an instruction depends on that instruction, and the argument values are stored in the address locations immediately after the instruction. In this embodiment, execution of the virtual machine instructions begins at the first instruction (located at A1) and continues with the next instruction (at A5), and so on. The address location of the next instruction is calculated by adding, to the address location of the current instruction, the number of arguments of the current instruction plus 1. In some embodiments, an instruction pointer indicating an address of the next instruction to be executed may be explicitly set by the instruction that is being executed.

In the data structure shown, the arguments (operands) are in columns labeled op1, op2, op3. The instructions and values to be stored as operands are described in more detail earlier above.

In implicit mode, an argument is may be used to specify a next address location to be processed. For example, the second argument (op2) in the virtual machine instructions is used in implicit mode and shows where the membership value corresponding to this element is found.

At s403, the conversion module 300 sends the determined virtual machine instructions representative of the discrete fuzzy input 210 to the execution module 302.

At s404, the user of the fuzzy calculation apparatus 200 sets a value of the alpha register, for example, using a user input of the fuzzy calculation apparatus 200. In other embodiments, a different entity instead of the user sets the value of the alpha register. The execution module 302 receives and stores the value of the alpha register. As noted above, the fuzzy calculation apparatus 200 is configured to determine the number of elements of the fuzzy input 210 that have a membership value greater than or equal to a user specified value. The value of the alpha register is set to be equal to this value. For example, in some embodiments, the user wants the fuzzy calculation apparatus 200 to find all elements of A having a membership value greater than or equal to 0.5; thus, at s404, the user sets the alpha register to be 0.5. In other embodiments, the alpha register is set to be equal to a different value, e.g. 0.

At s406, the execution module 302 executes the virtual machine instructions specified at s402 using the alpha register value specified at s404.

Execution of the virtual machine instructions starts by executing the first instruction at the first location, i.e. INIT at A1, and continues by executing the instructions at the subsequent rows in order, i.e. CGR at A5, then IAC at A7, and so on. In this embodiment, the execution module 302 calculates an address of the next instruction to be executed by adding 1 plus the number of arguments of the current instruction to the address of the current instruction (unless an instruction pointer is explicitly set by the instruction being executed, in which case the execution module 302 proceeds by executing the instruction at the address indicated by that pointer). Thus, since the virtual machine instructions are ordered by membership level m_{A}(x), the virtual machine instructions are executed in membership level order.

The following table (Table 1) illustrates the execution of the virtual machine instructions shown in Data Structure 1 above, with the alpha register value set to 0.5. Rows of the below table show register values at sequential time steps.

TABLE 1

| | | | | | continua- | | |
|---|---|---|---|---|---|---|---|
| execPtr | Commentary | container | alpha | alphaIsSet | tionPointer | execStatus | exec Mode |
| A1 | The virtual machine executes the | content = { } | 0.5 | T | — | R | E |
| | IMIT instruction and initializes | 1 argument | | | | | |
| | defuzzification process. | | | | | | |
| A5 | The virtual machine executes the | content = { } | 0.5 | T | — | R | E |
| | CGR instruction and compares | | | | | | |
| | the value stored in the alpha | | | | | | |
| | register (0.5) with the argument | | | | | | |
| | at A6 (1.0). Since alpha (0.5) is | | | | | | |
| | not greater than 1.0, the virtual | | | | | | |
| | machine moves to the next | | | | | | |
| | instruction. | | | | | | |
| A7 | The virtual machine sets the | execute <add> a | 0.5 | T | — | R | E |
| | container to call <add><object> | content = {a} | | | | | |
| | and executes the container | | | | | | |
| | command. Thus, the object at in | | | | | | |
| | the argument of IAC, i.e. the | | | | | | |
| | object at A8 (a), is added to the | | | | | | |
| | container. | | | | | | |
| A11 | The virtual machine executes the | content = {a} | 0.5 | T | — | R | E |
| | CGR instruction and compares | | | | | | |
| | the value stored in the alpha | | | | | | |
| | register (0.5) with the argument | | | | | | |
| | at A12 (0.9). Since alpha (0.5) is | | | | | | |
| | not greater than 0.9, the virtual | | | | | | |
| | machine moves to the next | | | | | | |
| | instruction. | | | | | | |
| A13 | The virtual machine sets the | execute <add> c | 0.5 | T | — | R | E |
| | container to call <add><object> | content = {a, c} | | | | | |
| | and executes the container | | | | | | |
| | command. Thus, the object at in | | | | | | |
| | the argument of IAC, i.e. the | | | | | | |
| | object at A14 (c), is added to the | | | | | | |
| | container. | | | | | | |
| A17 | The virtual machine executes the | content = {a, c} | | | | | |
| | CGR instruction and compares | | | | | | |
| | value stored in the alpha register | | | | | | |
| | (0.5) with the argument at A18 | | | | | | |
| | (0.5). Since alpha (0.5) is not | | | | | | |
| | greater than 0.5, the virtual | | | | | | |
| | machine moves to the next | | | | | | |
| | instruction. | | | | | | |
| A19 | The virtual machine sets the | execute <add> d | 0.5 | T | — | R | E |
| | container to call <add><object> | content = {a, c, d} | | | | | |
| | and executes the container | | | | | | |
| | command. Thus, the object at in | | | | | | |
| | the argument of IAC, i.e. the | | | | | | |
| | object at A20 (d), is added to the | | | | | | |
| | container. | | | | | | |
| A21 | The virtual machine executes the | content = {a, c, d} | 0.5 | T | — | T | |
| | CGR instruction and compares | | | | | | |
| | value stored in the alpha register | | | | | | |
| | (0.5) with the argument at A22 | | | | | | |
| | (0.4). Since alpha (0.5) is greater | | | | | | |
| | than 0.4, the virtual machine | | | | | | |
| | returns the contents of the | | | | | | |
| | container, i.e. {a, c, d} | | | | | | |

Thus, in this embodiment, by executing the virtual machine instructions that represent the fuzzy input and applying an alpha threshold of 0.5, the execution module 302 generates the crisp data set {a, c, d}. This crisp data set is the crisp input for the crisp processing module 206.

In other examples, different threshold values for the alpha register may result in different crisp data being generated by the defuzzification module 204. For example, setting a value of 0 in the alpha register produces the crisp data set {a, c, d, b} as the crisp input.

At s408, the execution module 302 sends the generated crisp input (i.e. {a, c, d}) to the crisp processing module 206.

At s410, the crisp processing module 206 performs a crisp process on the received crisp input to evaluate one or more functions that it is configured to evaluate.

In this embodiment, the crisp processing module 206 is configured to determine the cardinality of the received crisp input. Processing the crisp input {a, c, d}, the crisp processing module 206 returns or determines the value 3. The crisp processing module 206 provides the value of 3 as the crisp output.

At s412, the crisp processing module 206 sends the generated crisp output (i.e. 3) to the fuzzification module 208.

At s414, the fuzzification module 208 processes the received crisp output to generate therefrom the fuzzy output 212. In this embodiment, the fuzzification module 208 associates the crisp output with information used in the defuzzification process of s306. In particular, the crisp output is associated with the threshold membership value specified by the user at s304 (i.e. the alpha register value) to produce the following fuzzy output 212:

(number of elements of A with membership≥threshold value, threshold value)=(3, 0.5)

Thus, the crisp output specifies the number elements of the fuzzy input 210 that have a membership value greater than or equal to a user specified value, together with the user specified value.

Thus an example fuzzy calculation process performed on a discrete fuzzy input 210 is provided.

What will now be described is a further example fuzzy calculation process performed on a continuous fuzzy input 210. In this embodiment, the virtual machine uses mathematical functions to represent entities at any specified membership value between 0 and 1. In this embodiment, the container provides the following further commands for use with continuous fuzzy data:
setConstantValue. An argument of this command includes a constant value C. This instruction may cause the virtual machine to calculate the function f(x)=C, where x is a membership level between 0 and 1.
setLinearValue. An argument of this command includes constant values m and C. This instruction may cause the virtual machine to calculate the function f(x)=mx+C, where x is a membership level between 0 and 1.
setLinearInterval. An argument of this command include constant values m₁, C₁, m₂, and C₂. This instruction may cause the virtual machine to calculate the interval [m₁x+C₁, m₂x+C₂], where x is a membership level between 0 and 1.

Although in this embodiment, only linear functions are used to represent continuous fuzzy data, it will be appreciated by those skilled in the art that different commands may be provided to allow non-linear functions to specify continuous fuzzy data. For example, commands that specify quadratic or cubic functions may be implemented.

FIG. 5 is a process flow chart showing a further example fuzzy calculation process performed by the fuzzy calculation apparatus 200.

This example fuzzy calculation process is a process performed on a continuous interval valued fuzzy set.

Initially, at s500 the conversion module 300 of the defuzzification module 204 acquires the continuous interval valued fuzzy input 210.

For illustration purposes only, in this embodiment the continuous interval value fuzzy input 210 is defined by a mapping F from the universe U to the set of closed intervals in [0, 1]. Herein, F=[F_{lower}(x), Fᵤₚₚₑᵣ(x)], where F_{lower}(x) is a lower bound for the continuous interval value fuzzy input 210, Fᵤₚₚₑᵣ(x) is an upper bound for the continuous interval value fuzzy input 210, and x ∈[0,1] is a membership value.

A continuous interval valued fuzzy set may be representative of one or more physical entities or objects, such as devices, people, or buildings. The entities may have one or more attributes that are physical or network security attributes, i.e. attributes that relate to physical or network security. In some embodiments, a continuous interval valued fuzzy set may be representative of an event. Events may indicate a behavior, action, change, measurement of, or other occurrence relating to a physical entity. In some embodiments, the events are physical or network security events, i.e. events that relate to physical or network security. An event may have an attribute that relates to physical or network security.

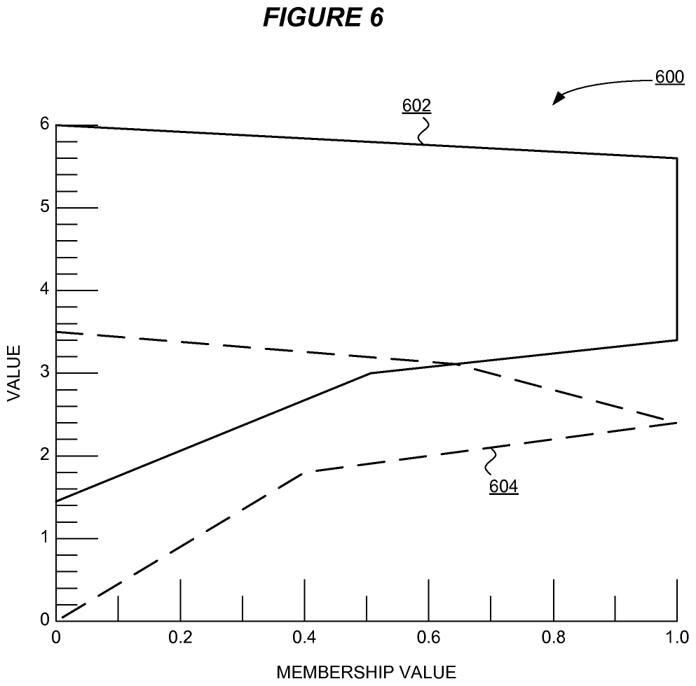

FIG. 6 is a schematic illustration (not to scale) of a graph 600 illustrating two different continuous interval valued fuzzy sets, hereinafter referred to as the “first interval valued set” 602 and the “second interval valued set” 604. The first interval valued set 602 may model a term such as a “half day” duration, with the x-axis representing a membership level and the y-axis representing a number of hours. The second interval valued set 604 may model a term such as a “couple of hours” duration, with the x-axis representing a membership level and the y-axis representing a number of hours. The first and interval valued sets 602, 604 may be derived from data, or from a user's subjective view.

At s502, the conversion module 300 converts the continuous fuzzy input 210 into a set of virtual machine instructions. In this embodiment, the virtual machine instructions corresponding to the continuous fuzzy input 210 comprise a sequence of operations representing the fuzzy input 210. Virtual machine instructions corresponding to first interval valued set 602 are given by the following data structure:

Data Structure 2.

| | | | | | | |
|---|---|---|---|---|---|---|
| INIT | 4 | B5 | B5 | | | |
| CGER | 1 | | | | | |
| SCC | 4 | SetLinearInterval | 1 | 2.5 | −0.4 | 6 |
| CGER | 0.5 | | | | | |
| ReplaceArg | 2 | 1 | 3 | 2 | 1.5 | |
| ETRM | 0 | | | | | |

In this embodiment, address locations of the elements of above Data Structure 2 are B1, B2, B3, . . . , and so on. Address locations are assigned in text reading order, i.e. such that the instruction “INIT” is at location B1, the value “4” is at location B2, the value “B5” is at location B3, the value “B5” is at location B4, the instruction “CGR” is at location B5, and so on. Empty boxes of the above data structure are not assigned an address.

The first column of the data structure (i.e. the “instruction” column of Data Structure 2) contains virtual machine instructions explained in more detail earlier above. The second and subsequent columns of the data structure contain the arguments of the instructions in the first column. Each instruction has a fixed (or easily determined) number of arguments which appear in the remaining columns of each row. The values stored in these arguments are as described in more detail earlier above.

Virtual machine instructions corresponding to second interval valued set 604 are given by the following data structure:

Data Structure 3.

| | | | | | | |
|---|---|---|---|---|---|---|
| INIT | 4 | C5 | 5 | | | |
| CGER | 1 | | | | | |
| SCC | 5 | SetLinearInterval | 1 | 1.4 | −2 | 4.4 |
| CGER | 0.6 | | | | | |
| ReplaceArg | 2 | 3 | −0.5 | 4 | 3.5 | |
| CGER | 0.4 | | | | | |
| ReplaceArg | 2 | 1 | 4.5 | 2 | 0 | |
| ETRM | 0 | | | | | |

In this embodiment, address locations of the elements of above Data Structure are C1, C2, C3, . . . , and so on. Address locations are assigned in text reading order, i.e. such that the instruction “INIT” is at location C1, the value “4” is at location C2, the first value “C5” is at location C3, the second value “C5” is at location C4, the instruction “CGR” is at location C5, and so on. Empty boxes of the above data structure are not assigned an address.

At s503, the conversion module 300 sends the determined virtual machine instructions representative of the continuous interval valued fuzzy input 210 to the execution module 302.

At s504, the user of the fuzzy calculation apparatus 200 sets a value of the alpha register, for example, using a user input of the fuzzy calculation apparatus 200. In other embodiments, a different entity instead of the user sets the value of the alpha register. The execution module 302 receives and stores the value of the alpha register.

In this example, the fuzzy calculation apparatus 200 is configured calculate the width of the input fuzzy interval 210 at a user specified value. This is a continuous analog of the discrete process of determining a number of elements of a discrete fuzzy input that have a membership value greater than or equal to a user specified value, which was described in more detail earlier above with reference to FIG. 4. The value of the alpha register is set to be equal to this user specified value.

At s506, the execution module 302 executes the virtual machine instructions specified at s502 using the alpha register value specified at s504. Execution is performed in the same way as described in more detail earlier above with reference to s406 of FIG. 4, i.e. by first executing the first instruction at the first location and continuing by executing the instructions at the subsequent rows in order.

Executing the virtual machine instructions for the first interval valued set 602 shown in Data Structure 2 above, with the alpha register value set to 0.45, leads to, prior to the execution of ETRM at B22, the command stack containing:

SetLinearInterval 1 2.5 −0.4 6

This evaluates [x+2.5, 6−0.4x]=[2.95, 5.82] with the value of x=0.45 (in the alpha register).

Executing the virtual machine instructions for the second interval valued set 604 shown in Data Structure 3 above, with the alpha register value set to 0.45, leads to, prior to the execution of CGER at C22, the command stack containing:

SetLinearInterval 1 1.4 −0.5 3.5

This evaluates [x+1.4, 3.5−0.5x]=[1.85, 3.275] with the value of x=0.45 (in the alpha register).

Thus, in this embodiment, by executing the virtual machine instructions that represent the continuous interval valued fuzzy input 210 and applying an alpha threshold of 0.45, the defuzzification module 204 generates a crisp data set, which includes [2.95, 5.82] for the first interval valued set 602 and [1.85, 3.275] for the second interval valued set 604.

At s508, the execution module 302 sends the generated crisp input to the crisp processing module 206. At s510, the crisp processing module 206 performs a crisp process on the received crisp input to evaluate one or more functions that it is configured to evaluate.

In this embodiment, the crisp processing module 206 is configured to determine the union of the received intervals that make up the received crisp input. Thus, the crisp processing module 206 determines the union of the intervals [2.95, 5.82] and [1.85, 3.275]. The crisp processing module 206 returns or determines an interval of [1.85, 5.82]. The crisp processing module 206 provides this interval of [1.85, 5.82] as the crisp output.

At s512, the crisp processing module 206 sends the generated crisp output (i.e. [1.85, 5.82]) to the fuzzification module 208.

At s514, the fuzzification module 208 process the received crisp output to generate therefrom the fuzzy output 212. In this embodiment, the fuzzification module 208 associates the crisp output with information used in the defuzzification process of s506. In particular, the crisp output is associated with the threshold membership value specified by the user at s504 (i.e. the alpha register value) to produce the following fuzzy output 212:

[1.85, 5.82] at membership 0.45

Thus, in this embodiment, the crisp output specifies an interval at a given membership value, together with that membership value.

Thus an example fuzzy calculation process performed on a continuous interval valued fuzzy input 210 is provided.

In the processes described above with reference to FIGS. 3 and 4, the fuzzy calculation apparatus 200 operates only in explicit mode. In explicit mode, the virtual machine instructions are executed so as to return an explicit value. In particular, in this embodiment, the alpha register is set to a specific explicit membership value, and the fuzzy calculation apparatus 200 executes the virtual machine instructions using this alpha register value to return an explicit value.

What will now be described is a further example fuzzy calculation process which may be performed by the fuzzy calculation apparatus 200 in which the fuzzy calculation apparatus 200 operates in implicit mode.

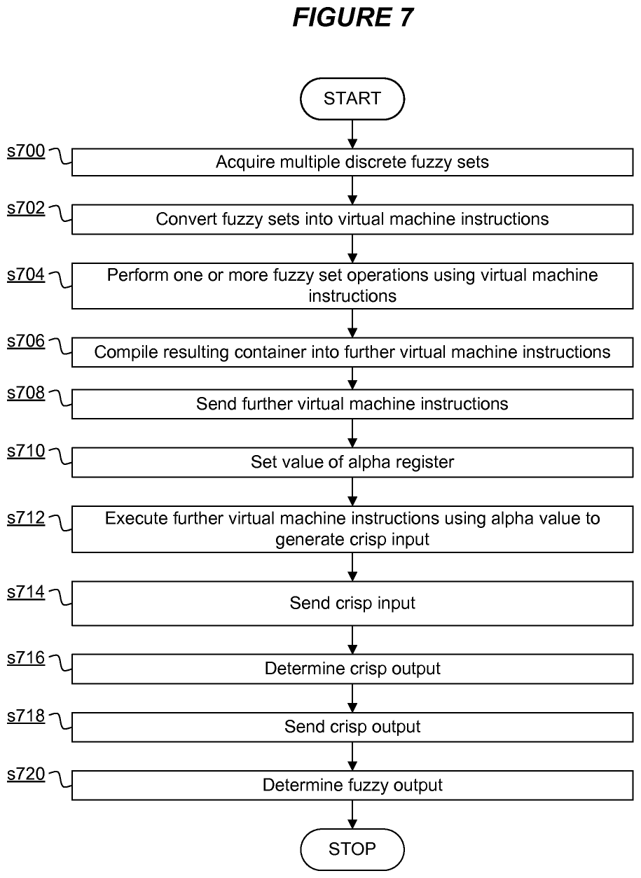

FIG. 7 is a process flow chart showing certain steps of an example fuzzy calculation process performed by the fuzzy calculation apparatus 200. In implicit mode, the virtual machine instructions are executed so as to return a sequence of operations (i.e. container commands) that do not specify an explicit value, but that may be used to produce an explicit output, for example, once a specific alpha register value is set. Advantageously, the container commands may be manipulated symbolically, for example using standard commercial software packages.

In this embodiment, the fuzzy calculation apparatus 200 is configured to determine the number elements of some function of the fuzzy input 210 that have a membership value greater than or equal to a user specified value. However, in other embodiments, fuzzy calculation apparatus 200 is configured to perform some other operation.

The example fuzzy calculation process described below with reference to FIG. 7 is a process performed on a discrete fuzzy input 210. However, in other embodiments, the process performed on a continuous fuzzy input, or a combination of discrete and continuous fuzzy inputs.

Initially, at s700 the conversion module 300 of the defuzzification module 204 acquires the discrete fuzzy input 210.

In this embodiment, the fuzzy input 210 comprises the discrete fuzzy set (A, m_{A})={a/1, b/0.4, c/0.9, d/0.5}, where A is a finite set containing employees that have managerial responsibility for a large number of junior employees.

In addition, the fuzzy input 210 comprises the discrete fuzzy set (D, m_{D})={b/0.2, c/1, d/1, e/0.4}, where B is a finite set containing employees that have control of a large budget. Also, a, b, c, d, and e are labels for respective employees.

At s702, the conversion module 300 converts the fuzzy input 210, i.e. (A, m_{A}) and (D, m_{D}), into a set of virtual machine instructions, e.g., in a similar way to as described in more detail earlier above at s402 of the process of FIG. 4.

As noted described above, in this embodiment virtual machine instructions corresponding to (A, m_{A})={a/1, b/0.4, c/0.9, d/0.5} are given by Data Structure 1:

Data Structure 1.

| instruction | op1 | op2 | op3 |
|---|---|---|---|
| INIT | 1 | A5 | A7 |
| CGR | 1.0 | | |
| IAC | a | A6 | A25 |
| CGR | 0.9 | | |
| IAC | c | A12 | A19 |
| CGR | 0.5 | | |
| IAC | d | A18 | A29 |
| CGR | 0.4 | | |
| IAC | b | A24 | A13 |
| TRM | | | |

Similarly, virtual machine instructions corresponding to (D, m_{D})={b/0.2, c/1, d/1, e/0.4} are given by Data Structure 4:

Data Structure 4.

| instruction | op1 | op2 | op3 |
|---|---|---|---|
| INIT | 1 | D5 | D23 |
| CGR | 1.0 | | |
| IAC | c | D6 | D11 |
| IAC | d | D6 | D17 |
| CGR | 0.4 | | |
| IAC | e | D16 | D27 |
| CGR | 0.2 | | |
| IAC | b | D22 | D7 |
| TRM | | | |

Similarly to Data Structure 1, address locations of the elements of above Data Structure 4 are D1, D2, D3, . . . , and so on. Address locations are assigned in text reading order, i.e. such that the instruction “INIT” is at location D1, the value “1” is at location D2, the value “D5” is at location D3, the value “D21” is at location D4, the instruction “CGR” is at location D5, and so on. Empty boxes of the above data structure are not assigned an address.

At s704, the conversion module 300 performs one or more fuzzy set operations on the fuzzy sets in the fuzzy input 210. In other embodiments, different processing of the fuzzy input 210, i.e. other than performing one or more fuzzy set operations, is performed instead of or in addition to performance of the fuzzy set operations.

In this embodiment, in performing s704, the conversion module 300 operates in implicit mode. In particular, no set value of the alpha register is used by the conversion module in the performance of s704, and no explicit values are returned by the conversions module 300. Instead, virtual machine instructions are generated.

By way of example, in this embodiment, the conversion module 300 processes the fuzzy input 210 to determine the intersection of the fuzzy sets (A, m_{A}) and (D, m_{D})

The following table (Table 2) illustrates the determination of the intersection of the fuzzy sets (A, m_{A}) and (D, m_{D}) by the conversion module 300. To determine the intersection, the conversion module 300 implements multithreaded execution and implicit mode. In particular, the conversion module 300 implements two threads (Thread 1 and Thread 2). Rows of Table 2 show register values for the two threads at sequential time steps. Also, the container provides two storage areas, one for each thread. Also, in Table 2, the execStatus may take the values R (indicating that the corresponding thread is running), S (indicating that the corresponding thread is suspended), or T (indicating that the corresponding thread is terminated). In this embodiment, at step s704, the execMode register for each thread is set to I (i.e. implicit mode) and is omitted from Table 2 for reasons of clarity.

| Thread 1 | | | | | Thread 2 | | | | | | |
|---|---|---|---|---|---|---|---|---|---|---|---|
| | | | continua- | | | | alpha | continua- | | | |
| execPtr | alpha | alphaIsSet | tionPointer | execStatus | exec Ptr | alpha | IsSet | tionPointer | execStatus | Commentary | container |
| A1 | — | F | — | R | D1 | — | F | — | R | initialize | content = { } |
| | | | | | | | | | | | 1 command, 1 |
| | | | | | | | | | | | argument and alpha |
| | | | | | | | | | | | per thread |
| | | | | | | | | | | | stack1 = empty |
| | | | | | | | | | | | stack2 = empty |
| A7 | — | F | — | R | D23 | — | F | — | R | each thread builds | content = { } |
| | | | | | | | | | | <add> command | stack1 = add a/1.0 |
| | | | | | | | | | | for lexically first | stack2 = add b/0.2 |
| | | | | | | | | | | element in the | |
| | | | | | | | | | | virtual machine | |
| | | | | | | | | | | instructions | |
| — | — | F | A25 | S | — | — | F | D7 | S | Container | content = { } |
| | | | | | | | | | | compares | stack1 = empty |
| | | | | | | | | | | arguments on | stack2 = add b/0.2 |
| | | | | | | | | | | stack. a is prior to | |
| | | | | | | | | | | b. Thread 2 | |
| | | | | | | | | | | remains | |
| | | | | | | | | | | suspended. Thread | |
| | | | | | | | | | | 1 stack is | |
| | | | | | | | | | | discarded and | |
| | | | | | | | | | | thread 1 is | |
| | | | | | | | | | | continued | |
| A25 | — | F | — | R | — | — | F | D7 | S | Thread 1 builds | content = { } |
| | | | | | | | | | | <add> command | stack1 = add b/0.4 |
| | | | | | | | | | | for lexically next | stack2 = add b/0.2 |
| | | | | | | | | | | element in the | |
| | | | | | | | | | | virtual machine | |
| | | | | | | | | | | instructions. | |
| — | — | F | A13 | S | — | — | F | D7 | S | Arguments (b) on | content = {b/0.2} |
| | | | | | | | | | | stack are identical. | stack1 = empty |
| | | | | | | | | | | Thus, b added to | stack2 = empty |
| | | | | | | | | | | content with | |
| | | | | | | | | | | membership 0.2. | |
| | | | | | | | | | | Restart both | |
| | | | | | | | | | | Threads | |
| A13 | — | F | — | R | D7 | — | F | — | R | each Thread | content = {b/0.2} |
| | | | | | | | | | | builds <add> | stack1 = add c/0.9 |
| | | | | | | | | | | command for | stack2 = add c/1.0 |
| | | | | | | | | | | lexically next | |
| | | | | | | | | | | element in the | |
| | | | | | | | | | | virtual machine | |
| | | | | | | | | | | instructions. | |
| — | — | F | A19 | S | — | — | F | D11 | S | Arguments (c) on | content = {b/0.2, |
| | | | | | | | | | | stack are identical. | c/0.9} |
| | | | | | | | | | | Thus, c added to | stack1 = empty |
| | | | | | | | | | | content with | stack2 = empty |
| | | | | | | | | | | membership 0.9. | |
| | | | | | | | | | | Restart both | |
| | | | | | | | | | | Threads | |
| A19 | — | F | — | R | D11 | — | F | — | R | each Thread | content = {b/0.2, |
| | | | | | | | | | | builds <add> | c/0.9} |
| | | | | | | | | | | command for | stack1 = add d/0.5 |
| | | | | | | | | | | lexically next | stack2 = add d/1.0 |
| | | | | | | | | | | element in the | |
| | | | | | | | | | | virtual machine | |
| | | | | | | | | | | instructions. | |
| — | — | F | A29 | S | — | — | F | D17 | S | Arguments (d) on | content = {b/0.2, |
| | | | | | | | | | | stack are identical. | c/0.9, d/0.5} |
| | | | | | | | | | | Thus, d added to | stack1 = empty |
| | | | | | | | | | | content with | stack2 = empty |
| | | | | | | | | | | membership 0.5. | |
| | | | | | | | | | | Restart both | |
| | | | | | | | | | | Threads. | |
| A29 | — | F | — | T | D17 | — | F | — | R | each Thread | content = {b/0.2, |
| | | | | | | | | | | builds <add> | c/0.9, d/0.5} |
| | | | | | | | | | | command for | stack1 = empty |
| | | | | | | | | | | lexically next | stack2 = add e/0.4 |
| | | | | | | | | | | element in the | |
| | | | | | | | | | | VM code | |
| | | | | | | | | | | Thread 1 | |
| | | | | | | | | | | terminates so | |
| | | | | | | | | | | execution | |
| | | | | | | | | | | terminates. Result | |
| | | | | | | | | | | is stored in | |
| | | | | | | | | | | container content. | |

In this embodiment, determining the intersection of the fuzzy sets (A, m_{A}) and (D, m_{D}) comprises the conversion module 300 systematically comparing the arguments (i.e. the employee labels a-e) of the two.

If the arguments being compared are identical, the conversion module 300 adds that argument to the container content together with a membership value equal to the minimum of the alpha values of the two compared arguments. The conversion module 300 then discards both of the compared arguments from the command stack and restarts both threads.

However, if the arguments being compared are not identical, the conversion module 300 discards the lexically prior argument. The thread from which the argument was discarded is then restarted.

In this embodiment, termination of either of the threads causes termination of the calculation, i.e. termination of s704.

At the end of the implicit mode execution process of s704, the container holds the following information: {b/0.2, c/0.9, d/0.5}. This may be expressed as the fuzzy set (E,m_{E})={b/0.2, c/0.9, d/0.5}.

At s706, the conversion module 300 compiles the container resulting from the implicit process of s704 into a further set of virtual machine instructions. In this embodiment, this is performed in the same way as the fuzzy input 210 is converted into virtual machine instructions at s702 above.

Virtual machine instructions corresponding to the container resulting from the process of s704, (E,m_{E})={b/0.2, c/0.9, d/0.5}, are given by Data Structure 5:

Data Structure 5.

| instruction | op1 | op2 | op3 |
|---|---|---|---|
| INIT | 1 | E5 | E19 |
| CGR | 0.9 | | |
| IAC | c | E6 | E13 |
| CGR | 0.5 | | |
| IAC | d | E12 | E23 |
| CGR | 0.2 | | |
| IAC | b | E18 | E7 |
| TRM | | | |

Similarly to the other Data Structures, address locations of the elements of above Data Structure 5 are E1, E2, E3, . . . , and so on. Address locations are assigned in text reading order, i.e. such that the instruction “INIT” is at location E1, the value “1” is at location E2, the value “E5” is at location E3, the value “E19” is at location E4, the instruction “CGR” is at location E5, and so on. Empty boxes of the above data structure are not assigned an address.

In this embodiment, (E,m_{E})=(A,m_{A})∩(D,m_{D}). Thus, the fuzzy set (E,m_{E}) represents employees with control over a large budget AND managerial responsibility for a substantial number of junior employees.

The virtual machine instructions representative of the fuzzy set (E,m_{E}) are stored by the container and are available for inspection and/or execution.

At s708, the conversion module 300 sends, to the execution module 302, the determined further virtual machine instructions representative of the intersection of the fuzzy sets (A, m_{A}) and (D, m_{D}).

At s710 to s720, an explicit mode processing by the fuzzy calculation apparatus 200 to determine the number elements of the determined intersection (of the fuzzy sets (A, m_{A}) and (D, m_{D})) that have a membership value greater than or equal to a user specified value is described. In this embodiment, s710 to s720 are performed in similar fashion to s404 to s414 respectively, which are described above with reference to FIG. 4.

At s710, the user of the fuzzy calculation apparatus 200 sets a value of the alpha register. At s712, the execution module 302 executes the further virtual machine instructions specified at s706 using the alpha register value specified at s712, thereby generating a crisp input. At s714, the execution module 302 sends the generated crisp input to the crisp processing module 206. At s716, the crisp processing module 206 performs a crisp process on the received crisp input to evaluate one or more functions that it is configured to evaluate, i.e. in this embodiment to determine the cardinality of the received crisp input. At s718, the crisp processing module 206 sends the generated crisp output to the fuzzification module 208. At s720, the fuzzification module 208 process the received crisp output to generate therefrom the fuzzy output 212. In this embodiment, the fuzzification module 208 associates the crisp output with the user-specified alpha register value used in the defuzzification process of step s712.

Thus an example fuzzy calculation process performed on a discrete fuzzy input 210 is provided. In this example, the fuzzy calculation apparatus 200 operates in implicit mode.

Advantageously, the wrapper for the crisp processing module 206 provided by the fuzzification and defuzzification modules 204, 208 is independent from the crisp processing module 206. Thus the wrapper tends to be widely applicable to multiple different crisp processors. The wrapper tends to provide for the widely applicable generalization of crisp calculation procedures to accept fuzzy data. Furthermore, this advantageously tends to provide that generalization of the crisp procedures to handle fuzzy data is provided without alteration of the internal processing of a crisp processor. Thus, the generalization of the crisp procedures to handle fuzzy tends to be highly efficient. Also, errors associated with modification of data processing systems for processing crisp data to support fuzzy data tend to be avoided. Furthermore, the wholesale rewrite of software in order to change data structures, and the collection of multiple sample values, tend to be avoided.

Advantageously, the above described apparatus provides two modes of operation. This tends to allows for answers to user defined question to be provided explicitly (i.e. as a value for any given membership level) and/or implicitly (i.e. as a formula or sequence of instructions for finding an explicit value as a function of membership).

Advantageously, the above described apparatus provides for multi-threaded execution. This tends to enable compound and/or parallel calculations to be performed efficiently.

Advantageously, the above described methods and apparatus are applicable to any set-based or interval-based processing operations where a graded membership can be assigned to elements of the set or sub-intervals. For example, applications of the apparatus and method to fuzzy control, fuzzy arithmetic, fuzzy association rule mining, and fuzzy formal concept analysis are possible.

Advantageously, using the above described apparatus, containers implementing complex fuzzy calculations such as fuzzy control, construction of fuzzy concept lattices, construction of activity graphs, etc. can be created easily

The above described method and apparatus tends to be applicable in many different fields including, but not limited to the evaluation of security rules and the like for attack detection or to determine an insecure state of system operation. Fuzzy set theory tends to be particularly useful in such fields as it provides an ability to handle definitions of terms and sets without having to give strict yes/no boundaries. For example, the notion of a network entity as malicious does not need to be given a strict boundary above which an entity is considered malicious and below which the entity is considered non-malicious. The usefulness of indistinct data is even more emphasized with more complex definitions of security threats such as “short sequence of minor alerts, closely spaced in time”, where “short”, “minor” and “closely” all essentially relate to indistinct data sets.

It should be noted that certain of the process steps depicted in the flowcharts of FIGS. 4, 5 and 7 and described above may be omitted or such process steps may be performed in differing order to that presented below and shown in those Figures. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, the fuzzy inputs to the fuzzy calculation apparatus are one or more discrete fuzzy sets, or one or more continuous fuzzy sets. In some embodiments, the fuzzy input comprises a combination of discrete and continuous fuzzy data.

In the above embodiments, the defuzzification module, operating in implicit mode, performs one or more fuzzy set operations on the received fuzzy input. Example fuzzy set operations include fuzzy complements, fuzzy intersections, and fuzzy unions. In other embodiments, different processing, i.e. other than performing one or more fuzzy set operations, is performed instead of or in addition to performance of the fuzzy set operations. For example, arithmetic operations can be performed as described in “The X-mu Representation of Fuzzy Sets—Regaining the Excluded Middle” (Trevor Martin and Ben Azvine, IEEE, 2013). In general x-mu numbers are represented by analytic functions mapping membership to value but for the purposes of describing exemplary embodiments of the present invention the flat linear segments described above are sufficient.

Also for example, methods of embodiments of the present disclosure may be implemented to determine a rule confidence value. A rule confidence value may be expressed as, for above fuzzy sets A and D, |A∩D|/|A|, where the notation | . . | represents cardinality of a set. Thus, using the sets A and D, the above described methods may be implemented to find the association strength for rules such as if an employee has managerial responsibility for a substantial number of junior employees then they usually also have control of a large budget. Calculating an association confidence, i.e. conf(A→D), may be performed, for example, by calculating the x-mu cardinality of the intersection of A and D, calculating the x-mu cardinality of A, then performing x-mu division to divide |A∩D| by |A|. The two cardinality calculations can be performed simultaneously using separate threads.

Some embodiments of the present disclosure are described with respect to assessing employee responsibilities. However, in alternative embodiments, other data which may be representative of one or more different entities other than employees may be processed. In alternative embodiments entities can include computer systems, network attached devices, network endpoints, software applications, computer programs or software agents for example such that typical behaviors of such entities are modeled in order to identify behavior and/or events departing from behavior. For example, typical network traffic generated by a network-attached computer system or software application can be processed to evaluate security rules and the like for attack detection and/or to determine an insecure state of system operation. In some embodiments, data generated by communications facilities such as telephony facilities including telephone call information, short message service information, mobile or wireless data service information such as call, message or communication times, types, durations, volumes, frequencies, contents and the like can be processed by methods of embodiments of the present invention.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A defuzzification apparatus for defuzzification of fuzzy data representative of one or more entities or events, the fuzzy data specifying a membership level for each of the one or more entities or events, the defuzzification apparatus comprising:
one or more processors configured to:
generate, using the fuzzy data, a set of computer executable instructions representative of a function of the fuzzy data; and
execute, using a predefined fuzzy membership value, the set of computer executable instructions to determine crisp data.

2. The defuzzification apparatus of claim 1, wherein each of the one or more entities is a physical entity, and each of the one or more events is a behavior, an action, or a change relating to the one or more physical entities.

3. The defuzzification apparatus of claim 1, wherein the one or more processors are further configured to:
generate, based on the fuzzy data, an initial set of computer executable instructions representative of the fuzzy data; and
determine the function of the fuzzy data by executing the initial set of computer executable instructions, thereby to generate the set of computer executable instructions representative of the function of the fuzzy data.

4. The defuzzification apparatus of claim 1, wherein the one or more processors is configured to implement multithread execution.

5. The defuzzification apparatus of claim 1, wherein the function of the fuzzy data is equal to one or more fuzzy set operators applied to some or all of the fuzzy data.

6. The defuzzification apparatus of claim 1, wherein the computer executable instructions in the set of computer implementable instructions are ordered by membership level.

7. The defuzzification apparatus of claim 1, wherein the one or more processors are configured to execute the set of computer implementable instructions in membership level order.

8. The defuzzification apparatus of claim 1, wherein the set of computer implementable instructions specifies a lexicographical ordering for the one or more entities or events.

9. A system comprising:
a defuzzification apparatus for defuzzification of fuzzy data representative of one or more entities or events, the fuzzy data specifying a membership level for each of the one or more entities or events, the defuzzification apparatus comprising one or more processors configured to:
generate, using the fuzzy data, a set of computer executable instructions representative of a function of the fuzzy data, and
execute, using a predefined fuzzy membership value, the set of computer executable instructions to determine crisp data,
wherein the defuzzification apparatus is configured to output the crisp data for use by one or more crisp data processors; and
a fuzzification apparatus comprising one or more processors configured to:
receive, responsive to the defuzzification apparatus outputting the crisp data, second crisp data from the one or more crisp data processors, and
process the received second crisp data to generate therefrom second fuzzy data.

10. The system of claim 9, wherein the fuzzification apparatus is configured to process the received second crisp data using the predefined fuzzy membership value.

11. The system of claim 9, further comprising the one or more crisp data processors, wherein the one or more crisp data processors are configured to:
receive the crisp data from the defuzzification apparatus;
perform crisp data processing on the received crisp data so as to generate the second crisp data; and
output the second crisp data for use by the fuzzification apparatus.

12. A defuzzification method for defuzzification of fuzzy data representative of one or more entities or events, the fuzzy data specifying a membership level for each of the one or more entities or events, the method comprising:
generating, using the fuzzy data, a set of computer executable instructions representative of a function of the fuzzy data; and
executing, using a predefined fuzzy membership value, the set of one or more computer executable instructions to determine crisp data.

13. A method according to claim 12, further comprising:
outputting the crisp data for use by one or more crisp data processors;
responsive to outputting the crisp data for use by one or more crisp data processors, receiving, from the one or more crisp data processors, second crisp data; and
processing the received second crisp data to generate therefrom second fuzzy data.

14. A program or plurality of programs arranged such that when executed by a computer system or one or more processors the program or the plurality of programs cause the computer system or the one or more processors to operate in accordance with the method claim 12.

15. A non-transitory computer-readable storage medium storing a program or at least one of the plurality of programs according to claim 14.
